(19) United States
(12) Patent Application Publication
(10) Pub. No.: US 2003/0177021 A1
(43) Pub. Date: Sep. 18, 2003

(54) Traceable business reply envelopes

(76) Inventor: Rana Dutta, Shelton, CT (US)

Correspondence Address: Geza C. Ziegler, Jr., PERMAN & GREEN, LLP, 425 Post Road, Fairfield, CT, 06824, US

(21) Appl. No.: 10/309,563

(22) Filed: Dec. 4, 2002

Related U.S. Application Data
(60) Provisional application No. 60/336,562, filed on Dec. 5, 2001.

(51) Int. Cl. G06F 17/60

(52) U.S. Cl. 705/1

(57) ABSTRACT

A system for forming a traceable mailpiece including an address database including at least one address to be placed on a mailer for the traceable mailpiece and a postal security device adapted to provide verifyable indicia. A controller relates the address from the database with a unique information based indicia to create a unique identifier indicia for the traceable mailpiece and a printer prints the unique identifier indicia on the traceable mailpiece, wherein the unique identifier allows the traceable mailpiece to be traced back to the address placed on the mailer.

### CROSS-REFERENCE TO RELATED APPLICATIONS

This application claims priority of pending provisional application No. 60/336,562, filed Dec. 5, 2001.

### BACKGROUND OF THE INVENTION

1. Field of the Invention

The present invention relates to mail processing, and more particularly, to identifying a source or sender of a mailpiece through digitally signed indicia.

2. Brief Description of Related Developments

The distribution of biological contaminants, such as for example anthrax, through the postal mail stream poses numerous threats and problems. Among the many problems is the inability to detect or determine from where a mailpiece originated if a genuine return address is not indicated. Unless a return address is specified and authenticated on the mailpiece, it can be nearly impossible to determine the origin of any one specific mailpiece.

Businesses that utilize “Business Reply Envelopes”, such as that shown in FIG. 1, generally have no way of knowing or authenticating the origin or identification of the mailer. Generally, these reply envelopes are used in mass mailings and the address of a recipient of such a mailing is only printed on the outer envelope in which the reply envelope is contained. The reply envelope tends to be generic and does not include any identifying indicia of the person mailing the reply envelope. The postage from these types of mailpieces are paid for by permit holder. The mailer of a Business Reply mailpiece can very easily remain anonymous. This can be problematic if the need arises to have to trace back or identify the mailer of a business reply envelope. Thus, there is an increasing need to be able to trace and identify the origin and/or mailer of a mailpiece. It would be helpful to be able to incorporate a unique identifier into a business reply mailpiece that identifies the origin or mailer of the mailpiece in a discrete and confidential fashion.

### SUMMARY OF THE INVENTION

The present invention is directed to a system for forming a traceable mailpiece. In one embodiment the system comprises an address database including at least one address to be placed on a mailer for the traceable mailpiece and a postal security device adapted to provide verifyable indicia. A controller relates the address from the database with a unique information based indicia to create a unique identifier indicia for the traceable mailpiece and a printer prints the unique identifier indicia on the traceable mailpiece, wherein the unique identifier allows the traceable mailpiece to be traced back to the address placed on the mailer.

In one aspect, the present invention is directed to a method of forming a traceable business reply envelope. In one embodiment the method comprises providing a postal security device; merging at least one mailing address from a database of mailing addresses for an intended recipient of a mailer including the reply envelope with verifyable indicia generated by the postal security device to create a unique identifier indicia; and forming the, unique identifier indicia on the reply envelope, the unique identifier allowing the reply envelope to be traced back to the intended recipient of the mailer.

In another aspect, the present invention is directed to a traceable mailpiece. In one embodiment the mailpiece comprises a destination address field; an optional return address field; and a digitally signed indicia field, the digitally signed indicia field including unique information identifying an original recipient of the traceable mailpiece that allows movement of the mailpiece through the postal system to be tracked.

In a further aspect, the present invention is directed to a computer program product. In one embodiment the computer program product comprises a computer readable program code means for causing a computer to relate a destination address of a mailer to a unique identifier; a computer readable program code means for causing a computer to form an indicia based on the relation between the destination address and the unique identifier; a computer readable program code means for causing a computer to print the indicia on a reply mailpiece included in the mailer, the indicia allowing an originator of the mailer to traceback the reply mailpiece to the destination address.

### BRIEF DESCRIPTION OF THE DRAWINGS

The foregoing aspects and other features of the present invention are explained in the following description, taken in connection with the accompanying drawings, wherein:

FIG. 1 is an illustration of a typical business reply envelope.

FIG. 2 is an illustration of one embodiment of a traceable business reply envelope incorporating features of the present invention.

FIG. 3 is a block diagram of one embodiment of a system that can be used to practice the present invention.

FIG. 4 is a flowchart of one embodiment of a method incorporating features of the present invention.

FIG. 5 is a block diagram of one embodiment of an apparatus that can be used to practice the present invention.

### DETAILED DESCRIPTION OF THE PREFERRED EMBODIMENT(s)

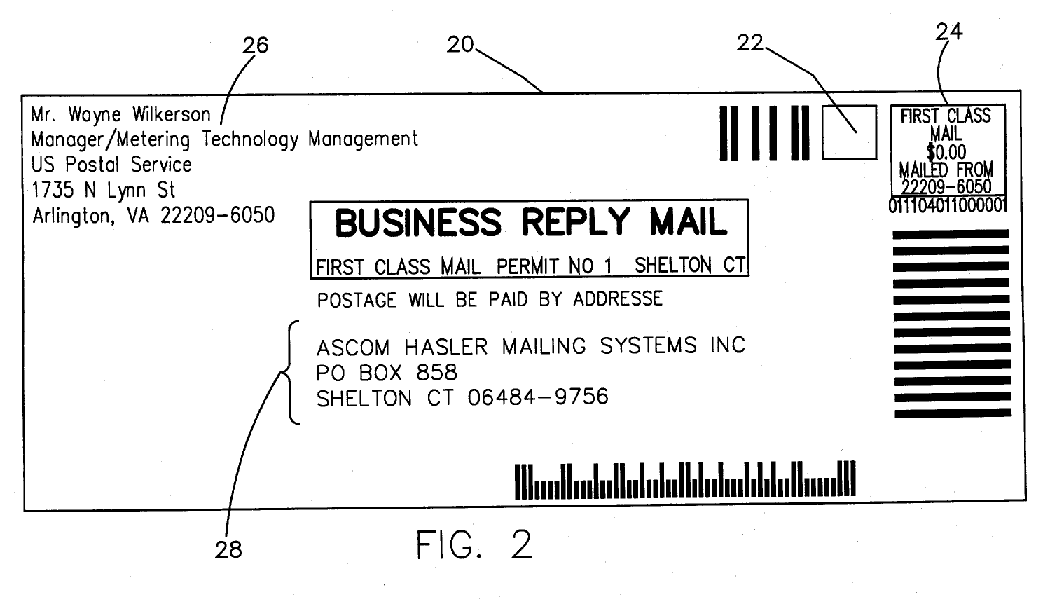

Referring to FIG. 2, an illustration of one embodiment of a mailpiece 20 incorporating features of the present invention is shown. Although the present invention will be described with reference to the embodiment shown in the drawings, it should be understood that the present invention can be embodied in many alternate forms of embodiments. In addition, any suitable size, shape or type of elements or materials could be used.

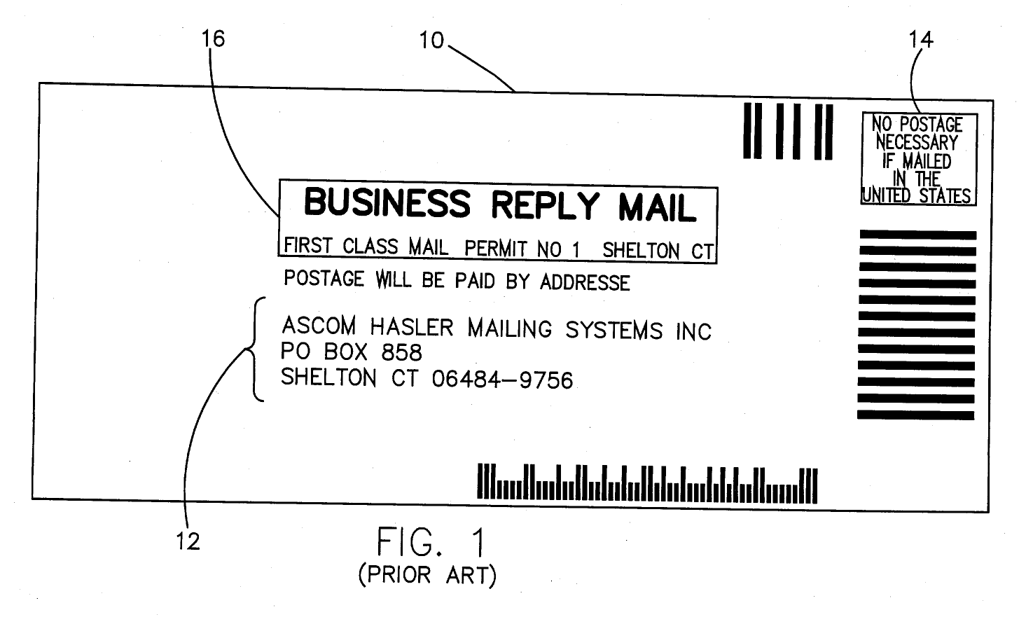

As shown in FIG. 1, a typical business reply envelope 10 generally includes a recipient address section 12, business reply permit data 16 and a return postage identifier 14. As shown in FIG. 1, the typical business reply envelope 10 does not include any information indicating who is mailing the envelope (the “mailer”) to the recipient 12. Although it might be possible to include a return address section, there is no guarantee that a “mailer” as the term is used herein, would fill it in. This is particularly true if the mailer wants to remain anonymous.

Business reply envelopes 10 can accompany mailers where it is desired to solicit the return of certain information and/or material. Since business reply envelopes 10 are generally used to encourage the return of the contents of the envelope to the addressee on the reply envelope, the return mail postage is prepaid. Since the permit holder is paying the postage, as reflected in the postage area 14, all that someone has to do is to deposit the reply envelope 10 in the mail. This of course, is advantageous for a person who wishes to remain anonymous.

In one embodiment, referring to FIG. 2, an envelope 20 incorporating features of the present invention will include at least one unique identifier 22, such as for example, a digitally signed indicia. Although reference is made herein to a digitally signed indicia, it will be understood that in alternate embodiments any suitable verifyable indicia can be used, such as for example, a bar code or digital stamp a hash, message authentication code (“MAC”), a MAC derived from a cryptographic hash code (“HMAC”) or other encrypted message. In one embodiment, the unique identifier could comprise a portion of a PostNet code. The identifier or indicia 22 can include information related to the mailer or sender of the reply mailpiece 20. As referred to herein, the “mailer or sender of the reply mailpiece” is generally intended to mean the originally intended recipient or “addressee” of the mailer or parcel that included the business reply envelope. As shown in FIG. 2, the envelope 20 can include an optional return address field 26. However, this information is not anonymous. It should be understood that although the use of a business reply envelope is referred to herein, the present invention can be applied to any item or object being processed through a mail type of system. For example, the indicia could be located on a parcel. The indicia 22 allows the mailpiece 20 to be traced. In one embodiment, the permit stamp 24 on the envelope could also include an identifying postal code or zip code of the mailer or replier. Although destination address fields and return address fields are referred to herein, in alternate embodiments the respective information can be included in or on any suitable portion of the object.

The identifier 22 allows the identification of at least the originally intended recipient of the reply envelope 20. For example, one item in a mass mailing could be addressed to Wayne Wilkenson as shown in field 26 of FIG. 2. If the reply envelope 20 is subsequently returned to the address 28 shown in FIG. 2, the identifier 22 will link the reply envelope 20 to the originally intended recipient shown in 26, even if no information is placed in field 26. This allows subsequent tracking of the envelope 20 to relate back to the originally intended recipient 26. The identifier 22 will allow the reply envelope 20 to be tracked, for example, through the USPS infrastructure until it is returned to the person or entity that initiated the direct mail campaign. The ability to track the item 20 will allow a delivery service, such as for example the USPS, to detect what equipment may have been potentially contaminated in the event that the item 20 is contaminated with a foreign agent. Although the present invention is described in terms of mailpieces and the USPS, it should be understood that the present invention can be utilized in any similar service for delivering documents and packages.

The identifier 22 also allows the sender or return mailer of the item 20 to remain anonymous, at least to the general public. Since the optional return address field 26 can remain blank, only the identifier 22 needs to be used to identify the sender, or at least the originally intended recipient and destination.

The identifier 22 could also include a physical device that is affixed to the envelope 20 and can be read by specialized equipment. For example, an RF tag that is programmed to correspond to the address 26 could be affixed in a non-removable fashion.

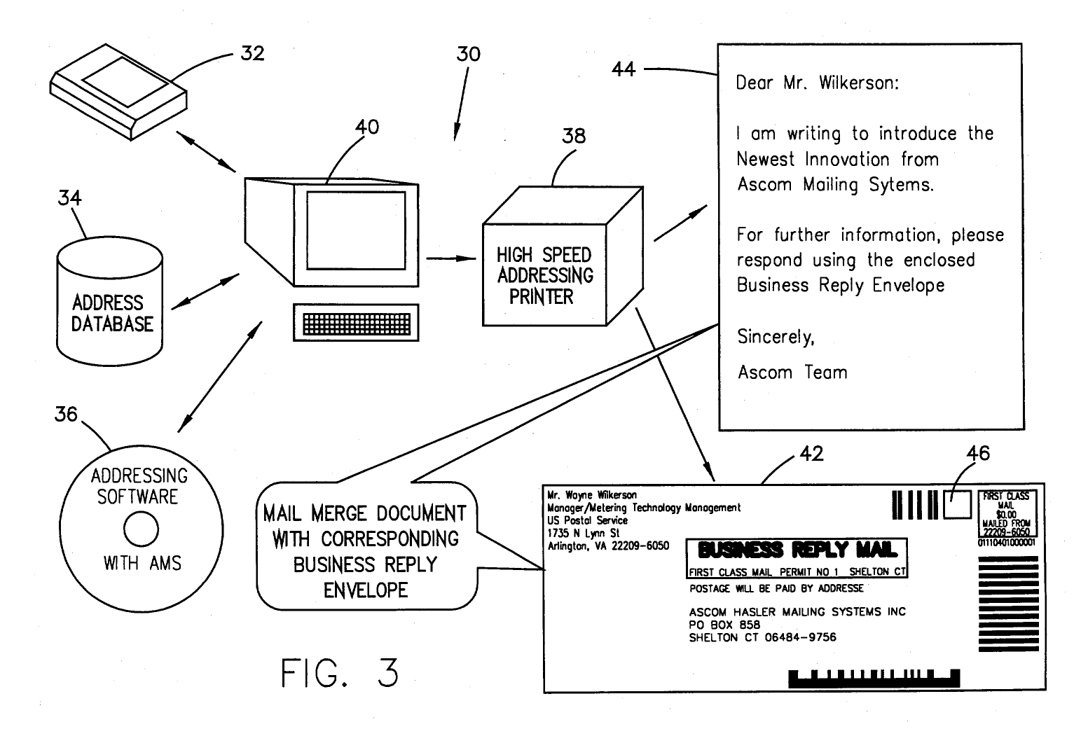

In one embodiment, referring to FIG. 3, a system 30 that can be used to produce a traceable mailpiece 42 incorporating features of the present invention is shown. The system generally comprises a host device 40, such as for example a computer system or device, a postal security device 32 and an address database 34. The host device or controller 40 is adapted to generate a unique identifier indicia 46 that can be printed or reproduced on the envelope 42. The host device 40 receives unique information based indicia from the postal security device 32 and address data from the address database 34 to generate the identification indicia 46.

Generally, through the use of the postal security device 32, which can be either physical or virtual, and addressing software 36 that can merge mailing addresses from the address database 34 with the information indicia, the mailpiece 42 including indicia 46 can be created. At the outset a supplier has a list of addresses to whom the document 44 is intended to be sent. Those addresses can be linked in any suitable fashion to a unique identifier such as for example, an information based indicia generated by the postal security device 32. The indicia 46 is digitally generated data and can be represented as graphical image, human readable information, various bar codes (both 1-dimensional or 2-dimensional codes), OCR characters, etc. or any combination thereof. With the indicia 46 printed on the envelope 42, the envelope 42 is traceable and not anonymous even though the indicia 44 is not decodable by the human eye.

The postal security device 32 is generally adapted to produce an information based indicia that is delivered to the host system 40. Examples of postal security devices that can be used with the present invention are disclosed in U.S. Pat. Nos. 6,009,417 and 6,069,616, the disclosures of which are incorporated herein by reference in their entireties. The PSD 32 is a security device that is used in conjunction with the host system 40 to create the Information Based Indicia and can be an “OPEN” or “CLOSED” system. The Information Based Indicia Program (IBIP) uses a two-dimensional symbol printed on the envelope to provide evidence that postage was paid, as well as providing additional information fields. This information is encoded into the symbol together with security information. The PSD can be implemented in hardware and provides a number of security functions, including cryptographic digital signature generation and verification. The PSD can also track the amount of postage available for postmark creation and the total postage value used by a given PSD. Postage can be loaded into the PSD by a remote communications link and the host system can provide the printing of the IBIP indicia.

As shown in FIG. 3 the PSD 32 can be implemented as a cartridge that can be inserted into and removed from the host system 40. In one embodiment, the PSD 32 can comprise a virtual or software based PSD instead of a physical PSD, an ASP or other similar providers can supply the digitally signed indicia.

The indicia 46 is printed on each piece of mail 42 using an IBIP symbol. Since the address data is different for each piece a unique and traceable identity is created for each piece of mail 42. The indicia 46 can be printed in any suitable location on the envelope. Although the term “printing” is used herein, any suitable form of marking can be used, and the scope of the invention is not limited to a printer.

For example, as shown in FIG. 3, a mail merge document 44 is adapted to be sent to a number of designated recipients together with a business reply envelope 42. The address of each recipient is stored in the address database 34. The addressing software 36 is then used to merge the mailing addresses from the address database 34 with the information based indicia from the PSD 32 to create the digitally signed or unique indicia 46 of the “mailer” of the business reply mail. The unique indicia 46 is then printed on the envelope 42.

The unique indicia 46 can be printed on the envelope by a high speed addressing printer 38, for example. In one embodiment, the high speed printer 38 could be a combination inserter and printer device, a collator system or a printer used in inserter applications. This gives the added benefit of automatic collating and inserting all in one step.

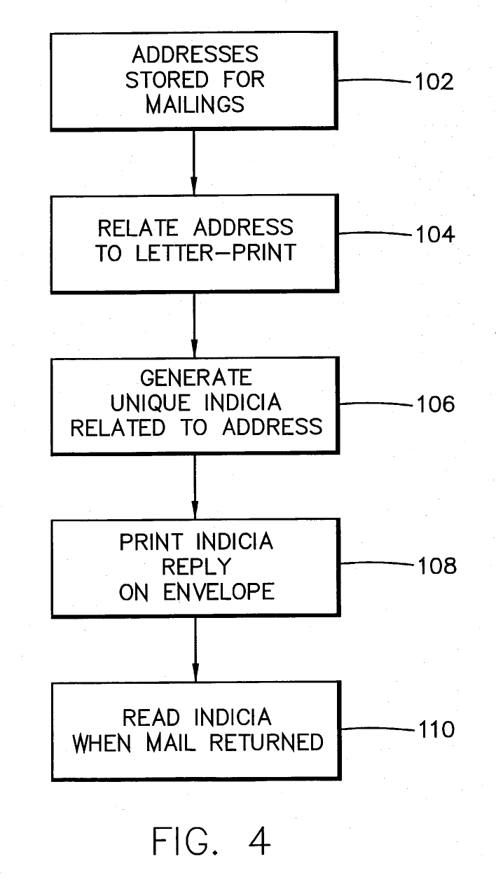

Referring to FIG. 4, one embodiment of a method incorporating features of the present invention is illustrated. As shown, addresses for the recipients of a mass-mailing or directed mailing are provided or stored (102) in an address database 34. The host computer system 40 uses the addressing software 36 to produce (104) the letter 44 with the destination printed thereon. This can include a mail merge together with address cleansing software. The computer system 40, in conjunction with the postal security device 32 and addressing software 36, produces (106) a unique indicia 46 that relates each reply envelope 42 to the recipient of the mailing. The indicia 46 is then printed (108) on the respective reply envelope 42. When the reply envelope 42 is sent back to the originator via return mail, the indicia 46 can be read (110) if desired to determine to whom the mail was originally sent. Thus when the originating company receives the returned mailpiece, they can easily determine to whom the mail was sent in the first instance.

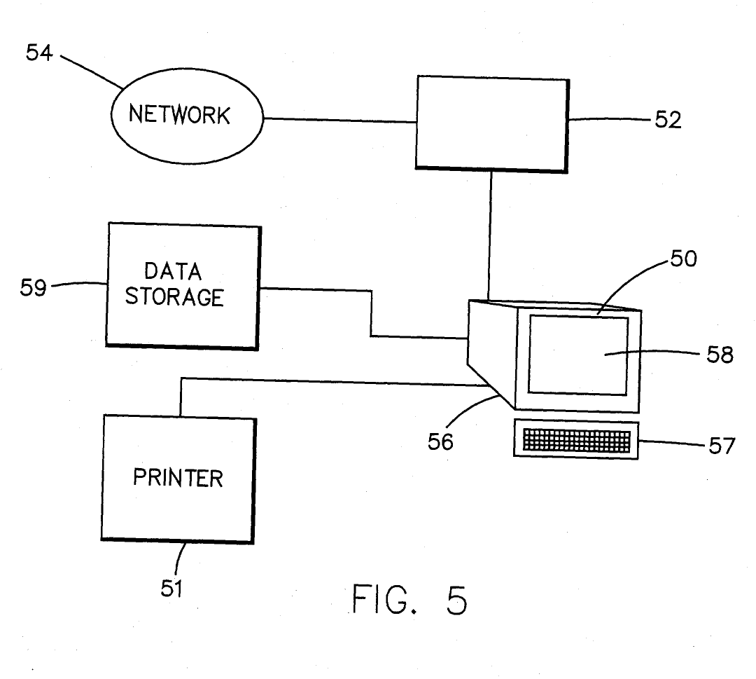

The present invention may also include software and computer programs incorporating the process steps and instructions described above that are executed in different computers. In the preferred embodiment, the computers are connected to the Internet. FIG. 5 is a block diagram of one embodiment of a typical apparatus incorporating features of the present invention that may be used to practice the present invention. As shown, a computer system 50 may be linked to another computer system 52, such that the computers 50 and 52 are capable of sending information to each other and receiving information from each other. In one embodiment, computer system 52 could include a server computer adapted to communicate with a network 54, such as for example, the Internet. Computer systems 50 and 52 can be linked together in any conventional manner including a modem, wireless or hard wire connection, or fiber optic link. Generally, information can be made available to both computer systems 50 and 52 using a communication protocol typically sent over a communication channel or through a dial-up connection on ISDN line. Computers 50 and 52 are generally adapted to utilize program storage devices embodying machine readable program source code which is adapted to cause the computers 50 and 52 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 50 and 52 may also include a microprocessor for executing stored programs. Computer 50 may include a data storage device 56 on its program storage device for the storage of information and data. Data could also be stored on an external system 59. The computer program or software incorporating the processes and method steps incorporating features of the present invention may be stored in one or more computers 50 and 52 on an otherwise conventional program storage device. In one embodiment, computers 50 and 52 may include a user interface 57, and a display interface 58 from which features of the present invention can be accessed. The display interface could also be an external printer or system 5. The user interface 57 and the display interface 58 can be adapted to allow the input of queries and commands to the system, as well as present the results of the commands and queries.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for forming a traceable mailpiece comprising:
an address database including at least one address to be placed on a mailer for the traceable mailpiece;
a postal security device adapted to provide a verifyable indicia;
a controller adapted to relate the address from the database with a unique information based indicia to create a unique identifier indicia for the traceable mailpiece; and
a printer adapted to print the unique identifier indicia on the traceable mailpiece, wherein the unique identifier allows the traceable mailpiece to be traced back to the address placed on the mailer.

2. The system of claim 1 wherein the address database is a database of a single address.

3. The system of claim 1 wherein the postal security device is a physical device.

4. The system of claim 1 wherein the postal security device is a virtual device.

5. The system of claim 1 wherein the verifyable indicia is an information based indicia.

6. The system of claim 1 wherein the verifyable indicia is a hash, HMAC or an encrypted message.

7. The system of claim 1 wherein the postal security device is further adapted to provide other digitally signed indicia including cryptographic data elements that can be used to derive a digital signature.

8. The system of claim 1 wherein the traceable mailpiece comprises a business reply envelope.

9. The system of claim 1 wherein the unique identifier comprises a digital stamp linking the traceable mailpiece to the address placed on the mailer associated with the traceable mailpiece.

10. The system of claim 1 wherein the unique identifier comprises a one-dimensional bar code.

11. The system of claim 1 further comprising an RF tag affixed to the traceable mailpiece, the RF tag being programmed to include information identifying an intended recipient of the mailer including the traceable mailpiece.

12. A method of forming a traceable business reply envelope comprising the steps of:
providing a postal security device;
merging at least one mailing address from a database of mailing addresses for an intended recipient of a mailer including the reply envelope with verifyable indicia generated by the postal security device to create a unique identifier indicia; and
forming the unique identifier indicia on the reply envelope the unique identifier allowing the reply envelope to be traced back to the intended recipient of the mailer.

13. The method of claim 12 wherein the unique identifier indicia is a digitally signed indicia unique to a replier of the business reply envelope.

14. The method of claim 13 wherein the unique identifier includes cryptographic data used to derive a digital signature.

15. The method of claim 12 wherein the unique identifier indicia on the reply envelope comprises a digital stamp linking the reply envelope to an original addressee of the mailer.

16. The method of claim 12 wherein the step of forming the unique identifier indicia on the reply envelope further comprises forming a digital image on the reply envelope.

17. A traceable mailpiece comprising:
a destination address field;
an optional return address field; and
a digitally signed indicia field, the digitally signed indicia field including unique information identifying an original recipient of the traceable mailpiece that allows movement of the mailpiece through the postal system to be tracked.

18. The traceable mailpiece of claim 17 wherein the unique information comprises address information identifying an original intended recipient of a mail item including the traceable mail piece.

19. The traceable mailpiece of claim 17, wherein the traceable mailpiece comprises a business reply envelope and the digitally signed indicia field on the business reply envelope includes information identifying an original addressee of a mailer including the business reply envelope.

20. The traceable mailpiece of claim 17 wherein the digitally signed indicia includes a one-dimensional bar code.

21. The traceable mailpiece of claim 17 wherein the digitally signed indicia includes information related to an addressee of a mailer including the traceable mailpiece, the digitally signed indicia allowing a recipient of the traceable mailpiece to trace back the traceable mailpiece to the addressee.

22. The traceable mailpiece of claim 17 wherein the indicia allows the mailpiece to be tracked through a postal type service.

23. A computer program product comprising:
a computer useable medium having computer readable code means embodied therein for causing a computer to form a traceable mailpiece, the computer readable code means in the computer program product comprising:
computer readable program code means for causing a computer to release a destination address of a mailer to a unique identifier;
computer readable program code means for causing a computer to forming an indicia based on the relation between the destination address and the unique identifier;
computer readable program code means for causing a computer to printing the indicia on a reply mailpiece included in the mailer, the indicia allowing an originator of the mailer to traceback the reply mailpiece to the destination address.
